(19) United States
(12) Patent Application Publication
(10) Pub. No.: US 2023/0161337 A1
(43) Pub. Date: May 25, 2023

(54) DIAGNOSTIC DEVICE, SERVER, AND DIAGNOSTIC METHOD

(71) Applicant: FANUC CORPORATION, Minamitsuru-gun, Yamanashi (JP)

(72) Inventors: Kazuhiro SATOU, Yamanashi (JP); Kazuhiro KOIZUMI, Yamanashi (JP)

(21) Appl. No.: 17/922,871

(22) PCT Filed: May 18, 2021
(86) PCT No.: PCT/JP2021/018740

§ 371 Date: Nov. 2, 2022

(30) Foreign Application Priority Data
May 25, 2020 (JP) 2020-090733

(51) Int. Cl. G05B 23/02; G06N 20/00

(52) U.S. Cl. CPC G05B 23/0283; G06N 20/00

(57) ABSTRACT

A diagnostic device, which is communicatively connected to a server that learns an abnormality of an industrial apparatus and generates a classification learning model for the abnormality, includes a sensor signal acquisition unit that acquires a sensor signal including a measurement value measured by a sensor in the industrial apparatus. The diagnostic device also includes an apparatus diagnosis unit that diagnoses whether the industrial apparatus is normal or abnormal based on the acquired sensor signal, a classification unit that classifies the abnormality based on the sensor signal and the classification learning model, when the industrial apparatus is abnormal, and a transmission unit that determines whether to transmit the sensor signal to the server based on the diagnosis result and/or and the classification result, and transmits the sensor signal to the server when it is determined that the sensor signal can be transmitted.

### TECHNICAL FIELD

The present invention relates to a diagnostic device, a server, and a diagnostic method.

### BACKGROUND ART

There are diagnostic devices that perform diagnosis (such as prediction and detection of out of order) for industrial devices such as machine tools and robots. In such diagnostic devices, it is necessary for vendors such as manufacturers and distributors of the industrial devices to collect sensor data of measurement values measured by sensors arranged in a user's industrial device for the purpose of functional improvement such as improvement of diagnosis accuracy.

In this regard, there is known a technique for: transmitting context information corresponding to a current operation of a target device and detection information such as sound data detected in the operation to a learning device; acquiring a model corresponding to the transmitted context information, from the learning device that combines models Generated from detection information corresponding to identical or similar context information, respectively; and determining using the detection information detected in the operation and the acquired model whether an operation of the target device is normal. For example, see Patent Document 1.

Patent Document 1: Japanese Unexamined Patent Application, Publication No.2018-25945

### DISCLOSURE OF THE INVENTION

### Problems to be Solved by the Invention

However, for example, it is difficult to constantly upload sensor data of the industrial device to a vender's server or the like. In other words, the capacity of sensor data of the industrial device is generally large, and uploading all the data will put pressure on a network bandwidth. Further, from the viewpoint of security, the industrial device is often not always connected to an external network.

In addition, when labeling (annotation) for sensor data is required, there is a problem that a load on a user increases when the number of target data is large.

Therefore, it is desirable to select only data that has a great influence on functional improvement at the vendor, and to upload the selected data to a server.

### Means for Solving the Problems

(1) An aspect of the present disclosure provides a. diagnostic device that is communicatively connected to a server configured to learn an anomaly of an industrial device and to generate a classification learning model for the anomaly, the diagnostic device including: a sensor signal acquisition unit configured to acquire a sensor signal including a measurement value measured by at least one sensor arranged in the industrial device; a device diagnosis unit configured to diagnose based on the acquired sensor signal whether the industrial device is normal or anomalous; a classification unit configured to classify the anomaly of the industrial device based on the sensor signal and the classification learning model when the device diagnosis unit diagnoses that the industrial device is anomalous; and a transmission unit configured to determine, based on at least one of a diagnosis result by the device diagnosis unit and a classification result by the classification unit, whether to transmit the sensor signal to the server, and transmits the sensor signal to the server when it is determined that the sensor signal can be transmitted.

(2) An aspect of the present disclosure provides a diagnostic device that is communicatively connected to a server including a classification learning model to which a sensor signal indicating an anomaly acquired by an industrial device is input to classify the anomaly and configured to learn a classification of the sensor signal that is not classifiable and to update the classification learning model, the diagnostic device including: a sensor signal acquisition unit configured to acquire a sensor signal including a measurement value measured by at least one sensor arranged in the industrial device; a device diagnosis unit configured to diagnose based on the acquired sensor signal whether the industrial device is normal or anomalous; a transmission unit configured to transmit the sensor signal to the server when the device diagnosis unit diagnoses that the industrial device is anomalous; and a label information generation unit configured to determine, based on a classification result for the sensor signal acquired from the server, a generation timing of a label indicating a content of the anomaly of the industrial device with respect to the sensor signal and generates the label, in which the transmission unit transmits the label to the server.

(3) An aspect of the present disclosure provides a server that is communicatively connected to the diagnostic device according to (1) above, the server including a classification model learning unit configured to learn the anomaly of the industrial device using a sensor signal received from the diagnostic device, generates the classification learning model, and transmits the generated classification learning model to the diagnostic device.

(4) An aspect of the present disclosure provides a server that is communicatively connected to the diagnostic device according to (2) above, the server including: a classification model learning unit configured to learn the anomaly of the industrial device using a sensor signal received from the diagnostic device and generates the classification learning model; and a classification unit configured to classify the anomaly of the industrial device based on the sensor signal and the classification learning model.

(5) An aspect of the present disclosure provides a diagnostic method using a diagnostic device that is communicatively connected to a server configured to learn an anomaly of an industrial device and to generate a classification learning model for the anomaly, the diagnostic method including: a sensor signal acquisition step of acquiring a sensor signal including a measurement value measured by at least one sensor arranged in the industrial device; a device diagnosis step of diagnosing, based on the acquired sensor signal, whether the industrial device is normal or anomalous; a classification step of classifying the anomaly of the industrial device based on the sensor signal and the classification learning model when the industrial device is diagnosed to be anomalous; and a transmission step of determining, based on at least one of a diagnosis result in the device diagnosis step and a classification result in the classification step, whether to transmit the sensor signal to the server, and transmitting the sensor signal to the server when it is determined that the sensor signal can be transmitted,

(6) An aspect of the present disclosure provides a diagnostic method using a diagnostic device that is communicatively connected to a server including a classification learning model to which a sensor signal indicating an anomaly acquired by an industrial device is input to classify the anomaly and configured to learn a classification of the sensor signal that is not classifiable and to update the classification learning model, the diagnostic method including: a sensor signal acquisition step of acquiring a sensor signal including a measurement value measured by at least one sensor arranged in the industrial device; a device diagnosis step of diagnosing, based on the acquired sensor signal, whether the industrial device is normal or anomalous; a transmission step of transmitting the sensor signal to the server when the industrial device is diagnosed to be anomalous; and a label information generation step of determining, based on a classification result for the sensor signal acquired from the server, a generation timing of a label indicating a content of the anomaly of the industrial device with respect to the sensor signal and generating the label, in which the transmission step includes transmitting the label to the server.

### Effects of the Invention

According to the aspect, it is possible to select only data that has a great influence on functional improvement at the vendor, and to upload the selected data to a server.

### BRIEF DESCRIPTION CF THE DRAWINGS

FIG. 1 is a functional block diagram showing a functional constitution example of a diagnosis system according to a first embodiment;

FIG. 2 is a flowchart illustrating a diagnosis process of a diagnostic device and a collection process of a server;

FIG. 3 is a flowchart illustrating an acquisition process of the diagnostic device and a learning process of the server;

FIG. 4 is a functional block diagram showing a functional constitution example of a diagnosis system according to a second embodiment;

FIG. 5 is a flowchart illustrating a diagnosis process of a diagnostic device and a collection process of a server;

FIG. 6 is a flowchart illustrating a learning process of the server; and

FIG. 7 is a diagram showing an example of a constitution of a diagnosis system.

### PREFERRED MODE FOR CARRYING OUT THE INVENTION

Hereinafter, a first embodiment of the present disclosure will be described with reference to the drawings.

### First Embodiment

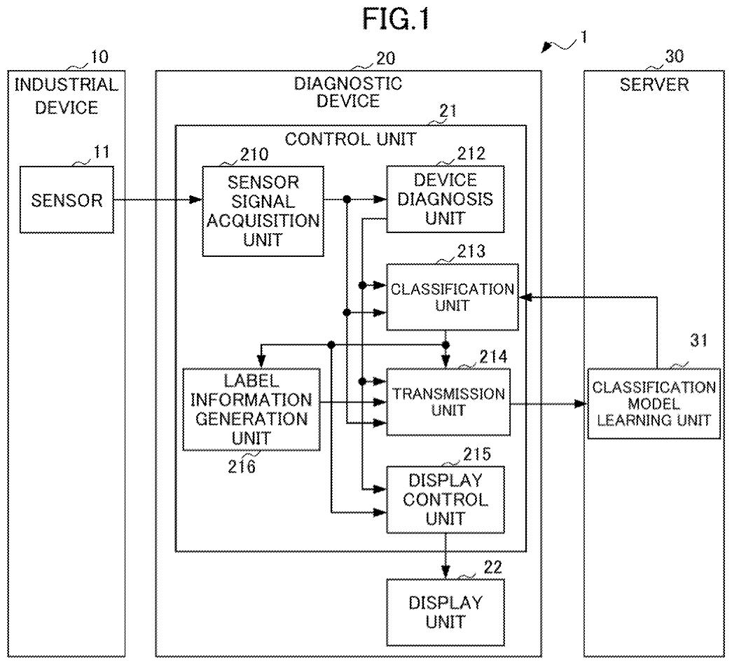

FIG. 1 is a functional block diagram showing a functional constitution example of a diagnosis system according to a first embodiment. As shown in FIG. 1, a diagnosis system 1 includes an industrial device 10, a diagnostic device 20, and a server 30.

The industrial device 10, the diagnostic device 20, and the server 30 may be connected to each other via a network (not shown) such as a LAN (Local Area Network) or the Internet. In this case, the industrial device 10, the diagnostic device 20, and the server 30 include a communication unit (not shown) configured to communicate with each other by such a connection. Further, the industrial device 10, the diagnostic device 20, and the server 30 may be directly connected to each other via a connection interface (not shown).

The industrial device 10 is a machine tool, an industrial robot or the like known to those skilled in the art, and includes a sensor 11. The industrial device 10 operates based on an operating instruction from a controller (not shown). The controller (not shown) is a numerical controller when the industrial device 10 is a machine tool, and as a robot controller when the industrial device 10 is a robot. Further, the controller (not shown) may be included in the industrial device 10.

The sensor 11 measures a state related to moving of a motor included in the industrial device 10 and movable parts (not shown) such as a spindle and an arm attached to the motor. The sensor 11 outputs a sensor signal including sensor data, which is a measurement value measured by the sensor 11, to the diagnostic device 20 so as to use the sensor data as data for diagnosis. The sensor 11 can be realized by any sensor, but can be realized by, for example, a sensor such as an acceleration sensor, an AE (Acoustic Emission) sensor, a temperature sensor, an ammeter, or a voltmeter.

Further, the sensor data measured by the sensor 11 may include feedback data for servo control (speed feedback and torque command calculated from the speed feedback).

In FIG. 1, the number of sensors 11 is one, but is not limited thereto. For example, the industrial device 10 may be arranged with a plurality of sensors 11 configured to measure the same type of sensor data, or may be arranged with a plurality of sensors 11 configured to measure sensor data of different types from each other.

### <Diagnostic Device 20>

The diagnostic device 20 includes a control unit 21 and a display unit 22. Further, the control unit 21 includes a sensor signal acquisition unit 210, a device diagnosis unit 212, a classification unit 213, a transmission unit 214, a display control unit 215, and a label information generation unit 216.

The display unit 22 is a display device such as an LCD (Liquid Crystal. Display). The display unit 22 displays, based. on a control instruction of the display control unit 215 to be described below, a diagnosis result of the industrial device 10 diagnosed by the device diagnosis unit 212 to be described below and a classification result of anomaly of the industrial device 10 classified by the classification unit 213 to be described below. Further, the display unit 22 may display, based on the control instruction of the display control unit 215, a user interface that receives an instruction to transmit the sensor data using the transmission unit 214 to be described below, the instruction being input via an input device (not shown) such as a keyboard or a touch panel included in the diagnostic device 20 from the user.

### <Control Unit 21>

The control unit 21 includes a CPU (Central Processing Unit) , a ROM (Read Only Memory) , a RAM, a CMOS (Complementary Metal-Oxide-Semiconductor) memory and the like, and these components are configured to be able to communicate with each. other via a bus, as is known to those skilled in the art.

The CPU is a processor that controls the diagnostic device 20 as a whole. The CPU reads out a system program and an application program stored in the ROM via the bus, and controls the entire diagnostic device 20 according to the system program and the application program. Thus, as shown in FIG. 1, the control unit 21 is configured to realize functions of the sensor signal acquisition unit 210, the device diagnosis unit 212, the classification unit 213, the transmission unit 214, the display control unit 215, and the label information generation unit 216. The RAM stores various data, for example, temporary calculation data and display data. Further, the CMOS memory is backed up by a battery (not shown) , and is configured as a non-volatile memory in which a storage state is retained even when the diagnostic device 20 is powered off.

The sensor signal acquisition unit 210 acquires a sensor signal including a measurement value (sensor data) measured by at least one sensor 11 arranged in the industrial device 10. The sensor signal acquisition unit 210 outputs the acquired sensor signal to the device diagnosis unit 212, the classification unit 213, and the transmission unit 214.

The device diagnosis unit 212 diagnoses based on the acquired sensor signal whether the industrial device 10 is normal or anomalous.

The device diagnosis unit 212 is, for example, a one-class classifier such as One-class SVM (Support Vector Machine) (hereinafter, also referred to as “one-class SVM”) or Gaussian mixture model. The device diagnosis unit 212 learns distribution of the sensor data in a normal state of the industrial device 10 in the same or similar operational condition of the industrial device 10, and determines to be anomalous with a deviation from the distribution of the sensor data in the normal state (that is, the degree of divergence), for example.

In the following description, the operational condition of the industrial device 10 will not be described, but in reality, a one-class classifier is generated for each operational condition. (context information) of the industrial device 10, and the diagnosis may be made on the industrial device 10 for each operational condition (context information) of the industrial device 10.

Specifically, the one-class classifier by the one-class SVM method is a method in which an SVM as a classification learning model for classifying sensor data into two classes (groups) is applied. The SVM obtains a hyperplane that classifies learning data whose classes are defined such that a distance (margin) between data of two classes is maximized, and uses the hyperplane to classify the sensor data to be determined as any of the classes. Then, the one-class classifier uses only one class of normal data as learning data to obtain a hyperplane that classifies the class of the learning data and the others, and classifies the sensor data using the obtained hyperplane. As a result, the one-class classifier creates a discrimination boundary that can surround most of the learning data through some of the learning data in a space of the sensor data, and classifies the sensor data to be determined as either normal or anomalous according to the discrimination boundary.

In other words, the device diagnosis unit 212, which is a one-class classifier based on the learning data in the normal state, can diagnose whether the sensor data is classified into a normal class of the learning data, that is, whether the industrial device 10 to be diagnosed is normal or anomalous. The device diagnosis unit 212 outputs the diagnosis result to the classification unit 213, the transmission unit 214, and the display control unit 215 which will be described below.

When the device diagnosis unit 212 diagnoses that the industrial device 10 is anomalous, the classification unit 213 classifies the anomaly of the industrial device 10 based on the sensor signal and the classification learning model co be described below.

Specifically, as will be described below, the classification unit 213 acquires (downloads) a one-class classifier as a classification learning model based on learning data of anomaly Aᵢ from the server 30, and adds the acquired one-class classifier, for example. The classification unit 213 determines using the added one-class classifier and the sensor data whether the sensor data is classified into a class of the learning data of the anomaly Aᵢ, that is, whether the anomaly of the industrial device 10 is the anomaly Aᵢ. The subscript i is an integer from 1 to n, and n is an integer of 1 or more.

In other words, the classification unit 213 classifies the anomaly of the industrial device 10 to be diagnosed, based on the sensor data of the industrial device 10 that is diagnosed to be anomalous by the device diagnosis unit 212. For example, the classification unit 213 uses the one-class classifier based on the learning data of each known anomaly A generated by the server 30 to be described below to determine whether the sensor data conforms to the learning data of the anomaly Aᵢ, whereby determining whether the anomaly of the industrial device 10 is the anomaly Aᵢ. On The other hand, when it is determined not to be any one from anomaly Aₗ to anomaly Aₙ, the classification unit 213 may determine that the sensor data is unknown data.

Then, the classification unit 213 outputs the classification result to the transmission unit 214. The display control unit 215, and the label information generation. unit 216.

Even when it is determined to be anomaly Aᵢ, if the number of sensor data corresponding to the determined anomaly Aᵢ is smaller than the preset number of samples, the classification unit 213 may determine that the sensor data is unknown data.

Further, when the classification learning model is a learned model of a neural network, the classification unit 213 may determine to be unknown data when a value of an output layer (softmax function) of the neural network is equal to or less than a predetermined value preset for all classes.

Further, when the classification learning model is the one-class classifier that is learned by input of data of all classes from the known anomaly Aₗ to the anomaly Aₙ, the classification unit 213 may determine to be unknown data when. the output of the one-class classifier is larger or smaller than a preset threshold value.

Further, the classification unit 213 acquires the one-class classifier based on the learning data of each known anomaly Aᵢ from the server 30, and classifies the anomaly of the industrial device 10 using the acquired one-class classifier and the sensor data, but is not limited thereto. For example, the classification unit 213 may acquire a classifier such as an SVM or a decision tree generated by machine learning in the server 30 to be described below from the server 30, and may classify the anomaly of the industrial device 10 using the acquired classifier such as the SVM or the decision tree and the sensor data.

Further, the classification unit 213 may be a one-class classifier that classifies as data from the anomaly Aₗ to the anomaly Aₙ known to the server 30 to be described below or unknown data.

The transmission unit 214 determines, based on the diagnosis result of the device diagnosis unit 212, the classification result of the classification unit 213, or both the results, whether to transmit the sensor signal to the server 30, and transmits the sensor signal to the server 30 when determining that the sensor signal is determined to be transmitted.

Specifically, when the device diagnosis unit 212 diagnoses that the industrial device 10 is anomalous and the classification unit 213 classifies the sensor data of the sensor signal as unknown data, the transmission unit. 214 determines that the sensor signal including the sensor data is transmitted to the server 30. Then, the transmission unit 214 transmits the sensor signal to the server 30.

In other words, the transmission unit 214 transmits only the sensor signal of the sensor data, which is determined to be unknown data by the classification unit 213 in the server 30, to the server 30, and thus a load on the network and a load on the user can be reduced.

When the transmission unit 214 transmits the sensor signal, the display control unit 215 displays, on the display unit 22, a user interface that urges the user to transmit the sensor signal at a timing when data transmission is necessary.

Specifically, the display control unit 215 may display, on the display unit 22, a user interface including a message such as “Please transmit data to the server 30” and a “transmit” button, at a timing when the transmission unit 214 transmits the sensor signal, for example.

Further, the display control unit. 215 may display, on the display unit 22, the diagnosis result of the device diagnosis unit 212, the classification result of the classification unit 213, or both the results.

The label information generation unit 216 determines, based on the classification result of the classification unit 213, a generation timing of a label indicating contents of the anomaly of the industrial device 10 with respect to the sensor signal, and generates a label for the sensor signal to be transmitted.

Specifically, the label information generation unit 216 Generates a label indicating contents of the anomaly of the industrial device 10 in a format in which an anomaly part and an anomaly phenomenon are combined, that is, in a format of “damage of spindle bearing”, “deterioration of guide sliding surface”, “damage of tool” or the like, at a timing when the transmission unit 214 transmits the sensor data determined to be unknown data by the classification unit 213, for example.

In addition, the label information generation unit 216 may generate a label based on the user's input such as anomalous noise and vibration generated at a time when the industrial device 10 becomes anomalous through an input device (not shown) of the diagnostic device 20, for example.

Further, the label information generation unit 216 may input the label by displaying a screen to urge the user to input the label on the display unit 22.

Further, the label information generation unit 216 may generate a label based on (another) sensor signal, a device operating situation, an environment situation and the like, at the acquisition time of the data to be labeled.

The label format is not limited to the format in which the anomaly part and the anomaly phenomenon are combined, and may be another format.

### <Server 30>

The server 30 is, for example, a computer device, and communicates with the diagnostic device 20 via a network (not shown). As shown in. FIG. 1, the server 30 includes a classification model learning unit 31.

The server 30 includes an arithmetic operation processing unit such as a CPU in order to realize a functional block of the classification model learning unit 31. Further, the server 30 includes not only an auxiliary storage device such as an HDD that stores various control programs including application software and an OS (Operating System), but also a main storage device such as a RAM that stores data temporarily required for The arithmetic operation processing unit to execute the programs.

Then, in the server 30, the arithmetic operation processing unit reads out the application software and the OS from the auxiliary storage device, deploys the read application software and OS, to the main storage device, and performs arithmetic operation processing based on such application software and OS. Further, based on the result of arithmetic operation, various hardware in the server 30 are controlled. Thus, the functional block of the present embodiment is realized. In other words, the present embodiment can be realized by cooperation of hardware and software.

In addition, each of the functions of the server 30 may be realized using a virtual server function or the like on a cloud.

The classification model learning unit 31 receives, for example, the sensor data determined to be unknown data by the diagnostic device 20 and the label from the diagnostic device 20. The classification model learning unit 31 stores the received sensor data and label in a storage zone corresponding to the contents of the label in a storage zone of a storage unit (not shown) such as an HDD included in the server 30.

Then, for example, when the number of sensor data in the storage zone for each label is equal to or more than the predetermined number of preset data, the classification model learning unit 31 obtains a hyperplane, which classifies a class as a new anomaly Aₙ₊₁ and the others, using only a one-class of sensor data as learning data in the storage zone, and newly generates a classification learning model of a one-class classifier that classifies sensor data using the obtained hyperplane. Then, the classification model learning unit 31 transmits the classification learning model, which classifies the newly generated anomaly Aₙ₊₁, to the diagnostic device 20.

The classification model learning unit 31 may construct a learned model of a neural network that predicts a probability (softmax function) of the anomaly Aₙ₊₁ in the output layer with respect to the input of the sensor data in the input layer by accepting a set of the sensor data of the anomaly Aₙ₊₁ and the label as training data and performing supervised learning using the accepted training data.

Further, the classification model learning unit 31 may Generate, for example, a classifier such as an SVM or a decision tree, or may generate a one-class classifier that classifies as data from the anomaly Aᵢ to the anomaly Aₙ known. to the server 30 or unknown data.

<Diagnosis Process of Diagnostic device 20 and Collection Process of Server 30>

Next, operations related to a diagnosis process of the diagnostic device 20 and a collection process of the server 30 will be described.

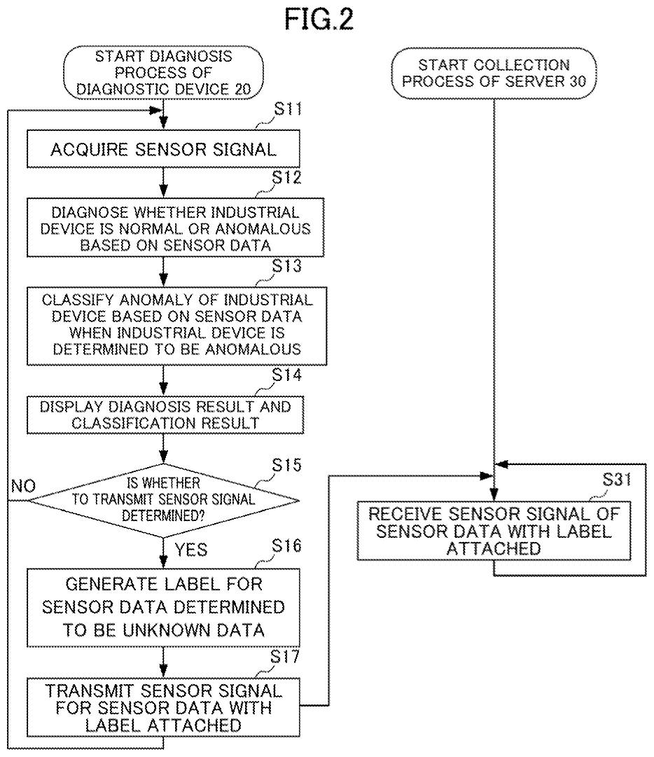

FIG. 2 is a flowchart illustrating a diagnosis process of the diagnostic device 20 and a collection process of the server 30.

In Step 311, the sensor signal acquisition unit 210 acquires sensor signal including sensor data measured by the sensor 11 of the industrial device 10.

In. Step S12, the device diagnosis unit 212 diagnoses, based on the sensor data of the sensor signal acquired in Step S11, whether the industrial device 10 is normal or anomalous.

In Step S13, when it is diagnosed in Step S12 that the industrial device 10 is anomalous, the classification unit 213 classifies the anomaly of the industrial device 10 based on the sensor data.

In Step S14, the display control unit 215 displays the diagnosis result and the classification result on the display unit 22.

In Step S15, the transmission unit 214 determines, based on the diagnosis result in Step S12, the classification result in Step S13, or both the results, whether to transmit the sensor signal. When the sensor signal is determined to be transmitted, the process proceeds to Step S16. On the other hand, when it is determined that the sensor signal cannot be transmitted, the process returns to Step S11.

In Step S16, the label information generation unit 216 determines a generation timing of a label for the sensor data determined to be unknown data in Step S13, and generates a label for the sensor data.

In Step S17, when the user presses the “transmit” button of the user interface displayed on the display unit. 22, the transmission unit 214 transmits the sensor signal of the sensor data of the unknown data with the label attached to the server 30. Then, the process returns to Step S11.

In Step S31, the classification model learning unit 31 of the server 30 receives the sensor signal of the sensor data of the unknown data with the label attached transmitted in Step S17, from the diagnostic device 20, and stores the received. sensor data and label in the storage zone corresponding to the contents of the label in the storage zone of the storage unit (not shown) of the server 30.

The diagnostic device 20 performs the process related to the acquisition of the sensor signal and the process related to the label generation and transmission of the unknown data in a time-series manner, but may execute the above processes in parallel or individually.

<Acquisition Process of Diagnostic Device 20 and Learning Process of Server 30>

Next, operations related to an acquisition process of the diagnostic device 20 and a learning process of the server 30 will be described.

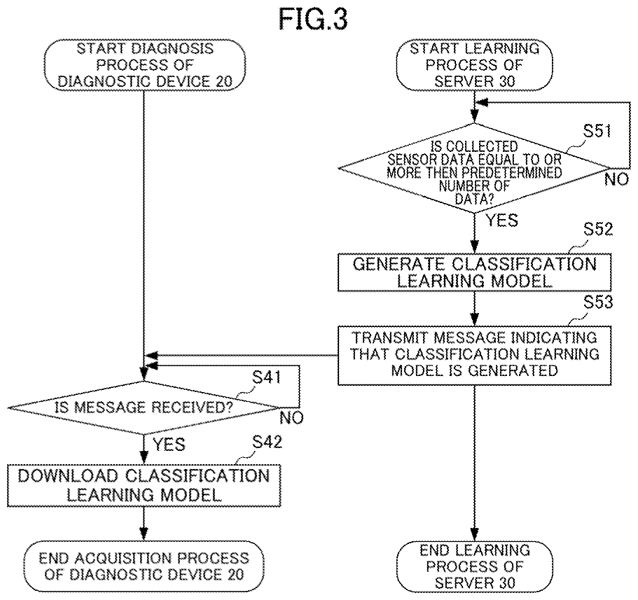

FIG. 3 is a flowchart illustrating an acquisition process of the diagnostic device 20 and a learning process of the server 30.

In Step S51, the classification model learning unit 31 determines whether the sensor data collected by the collection process in FIG. 2 is equal to or more than the predetermined number of preset data. When the collected sensor data is equal to or more than the predetermined number of data, the process proceeds to Step S52. On the other hand, when the collected sensor data is less than the predetermined number of data, the process waits in Step S51 until the sensor data becomes equal to or more than the predetermined number of data.

In Step S52, the classification model learning unit 31 performs machine learning using the sensor data collected to be equal to or more than the predetermined number of data and the labels, and thus generates a classification learning model that classifies as a new anomaly Aₙ₊₁.

In Step S53, the classification model learning unit 31 of the server 30 transmits a message to the diagnostic device 20 that the classification learning model for classifying the new anomaly Aₙ₊₁ is generated.

In Step S41, the classification unit 213 of the diagnostic device 20 determines whether to receive the message indicating that the classification learning model for classifying the new anomaly Aₙ₊₁ is generated, from the server 30. When the message is received, the process proceeds to Step S42. On the other hand, when the message is not received, the process waits in Step S41 until the message is received.

In. Step S42, the classification unit 213 downloads and acquires the generated classification learning model from the server 30.

The learning process of the server 30 exemplifies a mini-batch process, but may be replaced with a batch process or a real-time process instead of the mini-batch process.

As described above, the diagnostic device 20 according to the first embodiment acquires the sensor signal including the sensor data measured by the sensor 11 of the industrial device 10, and diagnoses based on the acquired sensor data whether the industrial device 10 is normal or anomalous. When i is diagnosed that the industrial device 10 is anomalous, the diagnostic device 20 classifies the anomaly of the industrial device 10 based on the sensor data. When the sensor data is determined to be unknown data by the classification, the diagnostic device 20 determines that the sensor data can be transmitted to the server 30, and transmits the sensor data to the server 30.

Thus, the diagnostic device 20 can select only unknown data that has a great influence on functional improvement at a vender, and can upload the selected unknown data to the server 30. Thereby, the diagnostic device 20 can reduce the load on the network.

Further, the diagnostic device 20 can reduce the user load by labelling (annotating) the selected unknown data uploaded to the server 30.

The first embodiment has been described above.

### <Second Embodiment>

Next, a second embodiment will be described.

In the first embodiment, the diagnostic device 20 diagnoses, using the sensor data included in the sensor signal from the sensor 11, whether the industrial device 10 is normal or anomalous, classifies the anomaly of the industrial device 10 using the classification learning mode generated by the server 30 and the sensor data when the industrial device 10 is diagnosed to be anomalous, and transmits the sensor data to the server 30 when the sensor data is determined to be unknown data. On the other hand, in the second embodiment, a diagnostic device 20A diagnoses, using the sensor data included in the sensor signal from the sensor 11, whether the industrial device 10 is normal or anomalous, transmits all sensor data, in which the industrial device 10 is diagnosed to be anomalous, to a server 30A, generates a label for the sensor data determined to be unknown data by the server 30A out of the transmitted sensor data, and transmits the label to the server 30A.

In other words, the second embodiment is different from the first embodiment in that the diagnostic device 20A diagnoses based on the acquired sensor signal whether the industrial device 10 is normal or anomalous, transmits the sensor signal to the server 30A when the industrial device is diagnosed to be anomalous, determines a generation timing of a label for the sensor signal based on the classification result for the anomaly of the industrial device 10 acquired from the server 30A to generate the label, and transmits the generated label to the server 30A.

Thus, the diagnostic device 20A can select only data that has a great influence on functional improvement at a vender and that the industrial device 10 is diagnosed to be anomalous, and can upload the selected data to the server 30A.

Hereinafter, the second embodiment will be described.

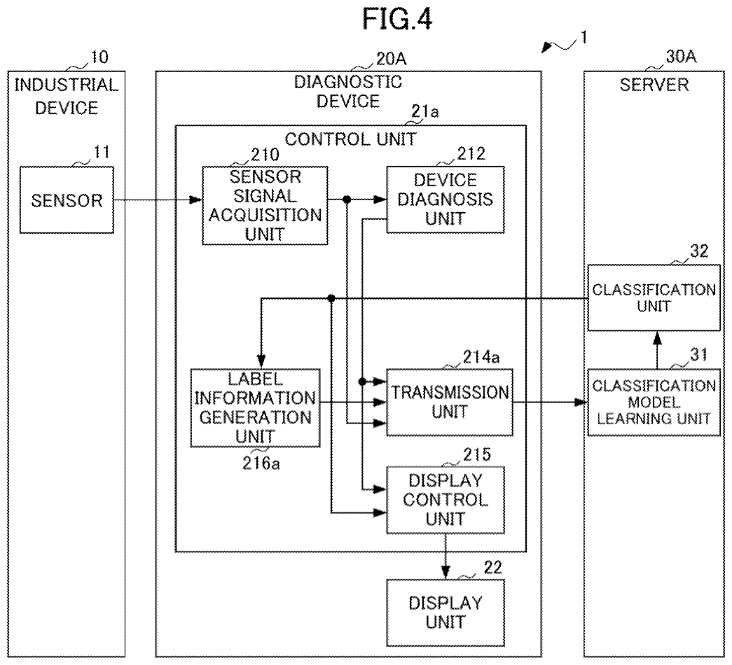

FIG. 4 is a functional bloc diagram showing a functional constitution example of a diagnosis system according to the second embodiment. Components having the same functions as the components of the diagnosis system 1 shown in FIG. 1 are denoted by the same reference numerals, and details thereof will not be described.

As shown in FIG. 4, a diagnosis system 1 according to the second embodiment includes an industrial device 10, a diagnostic device 20A, and a server 30A.

Similarly to the case of the first embodiment, the industrial device 10 is a machine tool, an industrial robot or the like known to those skilled in the art, and includes a sensor 11. The industrial device 10 operates based on an operating instruction from a controller (not shown).

Similarly to the case of the first embodiment, the sensor 11 measures a state related to moving of a motor included in the industrial device 10 and movable parts (not shown) such as a spindle and an arm attached to the motor. The sensor 11 outputs sensor data, which is a measurement value measured by the sensor 11, to the diagnostic device 20.

### <Diagnostic Device 20A>

The diagnostic device 20A includes a control unit 21a and a display unit 22. Further, the control unit 21a includes a sensor signal acquisition unit 210, a device diagnosis unit 212, a transmission unit 214a, a display control unit 215, and a label information generation unit 216a.

In the second embodiment, a function corresponding to the classification unit 213 of the first embodiment is realized as a classification unit 32 of the server 30A to be described below. In other words, the diagnostic device 20A according to the second embodiment does not classify the anomaly generated in the industrial device 10 using the sensor data measured by the sensor 11.

Further, the display unit 22 has the same function as the display unit 22 in the first embodiment.

<Control Unit 21a>

Similarly to the control unit 21 of the first embodiment, the control unit 21a includes a CPU (Central Processing Unit), a ROM (Read Only Memory), a RAM, a CMOS (Complementary Metal-Oxide-Semiconductor) memory and the like, and these components are configured to be able to communicate with each other via a bus, as is known to those skilled in the art.

The CPU is a processor that controls the diagnostic device 20A as a whole. The CPU reads out a system program and an application program stored in the ROM via the bus, and controls the entire diagnostic device 20A according to the system program and the application program. Thus, as shown in FIG. 4, the control unit. 21a is configured to realize functions of the sensor signal acquisition unit 210, the device diagnosis unit 212, the transmission unit 214a, the display control unit. 215, and the label information generation unit 216a.

The sensor signal acquisition unit 210, the device diagnosis unit 212, and the display control unit 215 have the same functions as the sensor signal acquisition unit 210, the device diagnosis unit 212, and the display control unit 215 in the first embodiment.

When the device diagnosis unit 212 diagnoses that the industrial device 10 is anomalous, the transmission unit 214 transmits the sensor signal to the server 30A.

In other words, the transmission unit 214a transmits only the sensor signal of the sensor data, for which industrial device 10 is diagnosed to be anomalous by the device diagnosis unit 212, to the server 30A, and thus a load on the network and a load on the user can be reduced.

Then, as will be described below, when the transmitted sensor data is classified as unknown data by the server 30A, the transmission unit 214a may transmit a label generated for The sensor data by the label information generation unit 216a, which will be described below, to the server 30A.

Upon receiving the classification result for the sensor signal transmitted by the transmission unit 214a from the server 30A to be described below, the label information generation unit 216a determines, based on the received classification result, a generation timing of a label indicating contents of the anomaly of the industrial device 10 with respect to the sensor signal and generates the label. The transmission unit 214a transmits the generated label to the server 30A.

Specifically, the label information generation unit 216a generates a label indicating contents of the anomaly of the industrial device 10 in a format in which an anomaly part and an anomaly phenomenon are combined, that is, in a format of “damage of spindle bearing”, “deterioration of guide sliding surface”, “damage of tool” or the like, at a timing when the transmission unit 214a receives the classification result, in which the sensor data of the sensor signal transmitted by the transmission unit 21-la is determined to be unknown data, from the server 30A.

In addition, the label information generation unit 216a may generate a label based on the user's input such as anomalous noise and vibration generated at a time when the industrial device 10 becomes anomalous through an input device (not shown) of the diagnostic device 20, for example.

Further, the label information generation unit 216a may input the label by displaying a screen to urge the user to input the label on the display unit 22,

Further, the label information generation unit 216a may generate a label based on (another) sensor signal, a device operating situation, an environment situation and the like, at the acquisition time of the data to be labeled.

The label format is not limited to the format in which the anomaly part and the anomaly phenomenon are combined, and may be another format.

### <Server 30A>

Similarly to the server 30 of the first embodiment, the server 30A is a computer device, and communicates with the diagnostic device 20A via a network (not shown). As shown in FIG. 4, the server 30A includes a classification model learning unit 31 and a classification unit 32.

The server 30A includes an arithmetic operation. processing unit such as a CPU in order to realize functional blocks of the classification model learning unit 31 and the classification unit 32. Further, the server 30A includes not only an auxiliary storage device such as an HDD that stores various control programs including application software and an OS, but also a main storage device such as a RAM that stores data temporarily required for the arithmetic operation processing unit to execute the programs.

Then, in the server 30A, the arithmetic operation processing unit reads out the application software and the OS from the auxiliary' storage device, deploys the read application software and OS to the main storage device, and performs arithmetic operation processing based on such application software and OS. Further, based on the result of arithmetic operation, various hardware in the server 30A are controlled. Thus, the functional block of the second embodiment is realized. In other words, the second embodiment can be realized by cooperation of hardware and software.

In addition, each of the functions of the server 30A may be realized using a virtual server function or the like on a cloud.

The classification model learning unit 31 has the same function as the classification model learning unit 31 of the first embodiment. However, the classification model learning unit 31 according to the second embodiment outputs the Generated classification learning model to the classification unit 32 to be described below.

The classification unit 32 classifies the anomaly of the industrial device 10, using the sensor data of the sensor signal, for which the industrial device 10 is diagnosed to be anomalous, received from the diagnostic device 20A, and the classification learning model generated by the classification model learning unit 31.

Specifically, similarly to the classification unit 213 of the first embodiment, the classification unit 32 classifies, using a one-class classifier based on learning data of an anomaly Aᵢ generated by the classification model learning unit 31 and the received sensor data, whether the received sensor data is classified into a class of the learning data of the anomaly Aᵢ, that is, whether the anomaly of the industrial device 10 is the anomaly Aᵢ, for example.

In other words, the classification unit 32 classifies the anomaly of the industrial device 10, based on the sensor data of the industrial device 10 that is diagnosed to be anomalous by the diagnostic device 20A. For example, the classification unit 32 uses the one-class classifier based on the learning data of each known anomaly Aᵢ generated by the classification model learning unit 31 to determine whether the received sensor data conforms to the learning data of the anomaly Aᵢ, whereby determining whether the anomaly of the industrial device 10 is the anomaly Aᵢ. On the other hand, when it is determined not to be any one from anomaly Aᵢ to anomaly Aₙ, the classification unit 32 determines that the corresponding sensor data is unknown data.

Then, the classification unit 32 outputs the classification result to the diagnostic device 20A.

Even when it is determined to be any anomaly Aᵢ, if the number of sensor data corresponding to the determined anomaly Aᵢ is smaller than the preset number of samples, the classification unit 32 may determine that the sensor data is unknown data.

Further, when the classification learning model is a learned model of a neural network, the classification unit 32 may determine to be unknown data when a value of an output layer (softmax function) of the neural network is equal to or less than a predetermined value preset for all classes.

Further, when the classification learning model is the one-class classifier that is learned by input of known data of all classes, the classification unit 32 may determine to be unknown data when the output of the one-class classifier is larger or smaller than a preset threshold value.

<Diagnosis Process of Diagnostic device 20A and Collection Process of Server 30A>

Next, operations related to a diagnosis process of the diagnostic device 20A and a collection process of the server 30A will be described.

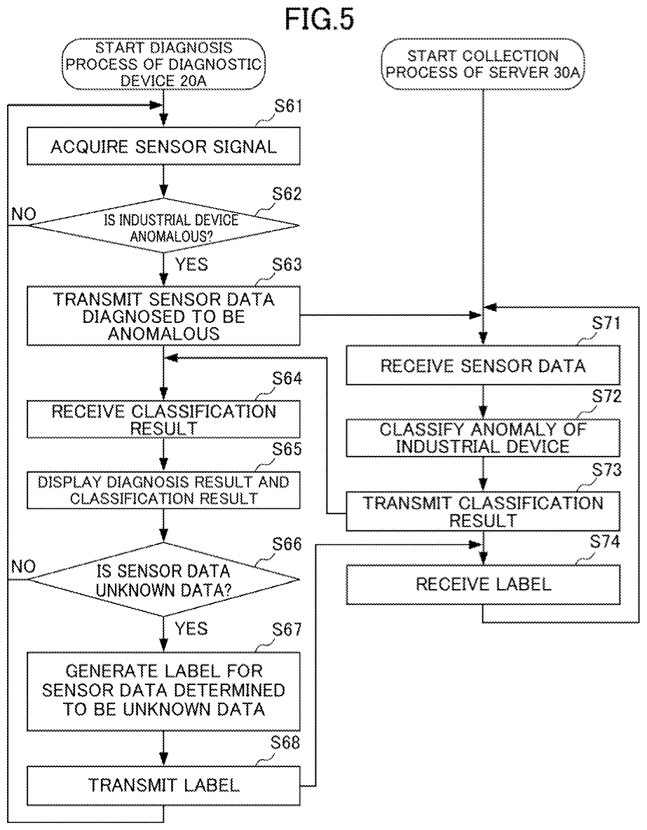

FIG. 5 is a flowchart illustrating a diagnosis process of the diagnostic device 20A and a collection process of the server 30A.

In Step S61, the sensor signal acquisition unit 210 performs the same process as in Step 11 of the first embodiment, and acquires sensor signal including sensor data measured by the sensor 11 of the industrial device 10.

In Step S62, the device diagnosis unit 212 diagnoses, based on the sensor data of the sensor signal acquired in Step S61, whether the industrial device 10 is anomalous. When the industrial device 10 is anomalous, the process proceeds to Step S63. On the other hand, when the industrial device 10 is normal, the process returns to Step S61.

In Step S63, the transmission unit. 214a transmits the sensor data, for which the industrial device 10 is diagnosed to be anomalous in Step S62, to the server 30A.

In Step S71, the classification unit 32 of the server 30A receives the sensor data, which is transmitted in. Step S63, from the diagnostic device 20A.

In Step S72, the classification unit 32 classifies the anomaly of the industrial device 10 based on the sensor data received in Step S71.

In Step S73, the classification unit 32 transmits the classification result classified in Step S72 to the diagnostic device 20A.

In Step S64, the display control unit 215 of the diagnostic device 20A receives the classification result from the server 30A.

In Step S65, the display control unit 215 performs the same process as in Step 14 of the first embodiment, and displays the diagnosis result and the classification result on the display unit 22.

In Step S66, the label information generation unit 216a determines, based on the classification result received in Step S64, whether the sensor data transmitted in Step S63 is classified as unknown data by the server 30A. When the sensor data is classified as unknown data, the process proceeds to Step S67. On the other hand, when the sensor data is not unknown data, that is, when the sensor data is classified as any data from the anomaly A₁ to the anomaly Aₙ, the process returns to Step S61.

In Step S67, the label information generation unit 216a determines a generation timing of a label for the sensor data classified as unknown data by the server 30A, and generates a label for the sensor data.

In. Step S68, when the user presses the “transmit” button of the user interface displayed on the display unit 22, the transmission unit 214a transmits the label generated in Step S67 to the server 30A. Then., the process returns to Step S61.

In Step S74, the classification model learning unit. 31 receives the label of the sensor data classified as unknown data in Step S72, from the diagnostic device 20A, and stores the received sensor data and label in the storage zone corresponding to the contents of the label in the storage zone of the storage unit (not shown) of the server 30A.

The diagnostic device 20A performs the process related to the acquisition of the sensor signal and the process related. to the label generation and transmission of the unknown data in a time-series manner, but may execute the above process in parallel or individually.

Further, the server 30A performs the processes of Steps S71 to S73 and the process of Step S74 in a time-series manner, but may execute the above process in parallel or individually.

### <Learning Process of Server 30A>

Next, an operation related to a learning process of the server 30A will be described.

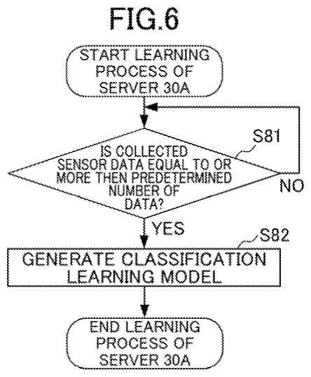

FIG. 6 is a flowchart illustrating a learning process of the server 30A.

In Step S81, the classification model learning unit 31 performs the same process as in Step S1 of the first embodiment, and determines whether the sensor data collected by the collection process in FIG. 5 is equal to or more than the predetermined number of preset data. When the collected sensor data is equal to or more than, the predetermined number of data, the process proceeds to Step S82. On the other hand, when the collected sensor data is less than the predetermined. number of data, the process waits in Step S81 until the sensor data becomes equal to or more than the predetermined number of data.

In Step S82, the classification model learning unit 31 performs the same process as in Step 52 of the first embodiment, and performs machine learning using the sensor data collected to be equal to or more than the predetermined number of data and the labels, and thus generates a classification learning model that classifies as a new anomaly and outputs the generated classification learning model co the classification unit 32.

The learning process of the server 30A exemplifies a mini-batch process, but may be replaced with a batch process or a real-time process instead of the mini-batch process.

As described above, the diagnostic device 20A according to the second embodiment acquires the sensor signal including the sensor data measured by the sensor 11 of the industrial device 10, and diagnoses based on the acquired sensor data whether the industrial device 10 is normal or anomalous. When it is diagnosed that the industrial device 10 is anomalous, the diagnostic device 20A transmits the acquired sensor signal to the server 30A. When the sensor data transmitted by the server 30A is determined to be unknown data, the diagnostic device 20A generates a label for the sensor data and transmits the generated label to the server 30A.

Thus, the diagnostic device 20A can select only data diagnosed as an anomaly of the industrial device 10 having a Great influence on functional improvement at a vender, and can upload the selected data to the server 30A. Thereby, the diagnostic device 20A can reduce the load on the network.

Further, the diagnostic device 20A can reduce the user load by labelling (annotating) the data determined to be unknown by the server 30A among the transmitted data diagnosed as an anomaly of the industrial device 10.

The second embodiment has been described above.

Although the first and second embodiments have been described above, the diagnostic device 20 or 20A, and the server 30 or 30A are not limited to the above-described embodiments, and may be modified and improved within a range in which the object can be achieved.

### <Modification Example 1>

In the first and second embodiments, the diagnostic device 20 or 20A is exemplified as a device different from the industrial device 10, but the industrial device 10 may be provided with a part or all of the functions of the diagnostic device 20 or 20A.

Alternatively, the server may include a part or all of the sensor signal acquisition unit 210, the device diagnosis unit 212, the classification unit. 213, the transmission unit 214, the display control unit 215, and the label information generation unit 216 of the diagnostic device 20, or a part or all of the sensor signal acquisition unit 210, the device diagnosis unit 212, the transmission unit 214a, the display control unit 215, and the label information generation unit 216a of the diagnostic device 20, for example. Further, each function of the diagnostic device 20 or 20A may be realized using a function of a virtual server or the like on the cloud.

Further, the diagnostic device 20 or 20A may be a distributed processing system in which the function of the diagnostic device 20 or 20A is appropriately distributed to a plurality of servers.

### <Modification Example 2>

In addition, for example, in the first and second embodiments described above, the diagnostic device 20 or 20A is connected to one industrial device 10, but may be connected to a plurality of industrial devices 10 without being limited thereto.

### <Modification Example 3>

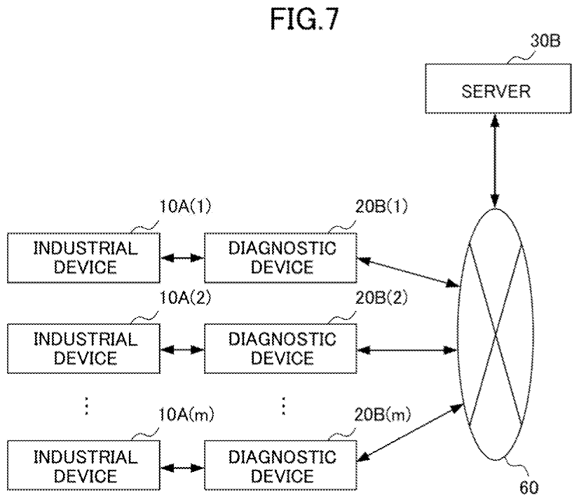

Further, for example, in the first and second embodiments described above, the server 30 or 30A is connected to one diagnostic device 20 or 20A, but is not limited thereto. For example, as shown in FIG. 7, a server 30B may store a classification learning model generated by a classification model learning unit 31 of the server 30B for each of industrial devices 10A(1) to 10A(m), and may share the classification learning model with m diagnostic devices 20B(1) to 20 (m) connected to a network 60 (m is an integer of 2 or more). Thus, the classification learning model can be applied even when new industrial device and diagnostic device are arranged.

Each of the diagnostic devices 20B (1) to 20B (m) is connected to each of the industrial devices 10A(1) to 10A(m).

Further, each of the industrial devices 10A(1) to 10A (m) corresponds to the industrial device 10 of the first and second embodiments, and may be the same model or different models from each other. Each of the diagnostic devices 20B(1) to 20B(m) corresponds to the diagnostic device 20 of the first embodiment or the diagnostic device 20A of the second embodiment. The server 30B corresponds to the server 30 of the first embodiment, or the server 30A of the second embodiment.

Each of the functions included in the diagnostic device 20 or 20A and the server 30 or 30A of the first and second embodiments can be realized by hardware, software, or a combination thereof. Here, it means that the realizing of such a function by the software is realized when a computer reads and executes a program.

The program may be stored and supplied to a computer using various types of non-transitory computer readable media. The non-transitory computer readable media include various types of tangible storage media. Examples of the non-transitory computer readable media include a magnetic recording medium (for example, a flexible disk, a magnetic tape, and a hard disk drive) , a magneto-optic recording medium (for example, a magneto-optic disk), a CD-ROM (Read Only Memory), a CD-R, a CD-R/W, and a semiconductor memory (for example, a mask ROM, a PROM (Programmable ROM), an EPROM (Erasable PROM), a flash. ROM, and a RAM). Further, these programs may be supplied to computers using various types of transitory computer readable media. Examples of the transitory computer readable media include an electrical signal, an optical signal, and an electromagnetic wave. The transitory computer readable media can supply programs to a computer through a wired communication line, for example, electric wires and optical fibers, or a wireless communication line.

In addition, the steps of describing the program to be recorded on the recording medium include not only a process performed sequentially in a time-series manner but also a process executed in parallel or individually without being necessarily processed in a time-series manner.

In other words, the diagnostic device, the server, and the diagnostic method of the present disclosure can take various embodiments having the following configurations.

(1) An aspect of the diagnostic device 20 of the present disclosure provides a diagnostic device that is communicatively connected to a server 30 configured to learn an anomaly of an industrial device 10 and to generate a classification learning model for the anomaly, the diagnostic device including: a sensor signal acquisition unit 210 configured to acquire a sensor signal including a measurement value measured by at least one sensor 11 arranged in the industrial device 10; a device diagnosis unit 212 configured. to diagnose based on the acquired sensor signal whether the industrial device 10 is normal or anomalous; a classification unit 213 configured to classify the anomaly of the industrial device based on the sensor signal and the classification learning model when the device diagnosis unit 212 diagnoses that the industrial device 10 is anomaly; and a transmission unit 214 configured to determine, based on at least one of a diagnosis result by the device diagnosis unit 212 and a classification result by the classification unit 213, whether to transmit the sensor signal to the server 30, and transmits the sensor signal to the server 30 when it is determined that the sensor signal can be transmitted.

According to the diagnostic device 20, it is possible to select only the data having a great influence on the functional improvement at the vender and to upload the selected data on the server.

(2) in the diagnostic device 20 according to (1) described above, the classification unit 213 may classify the sensor signal as unknown data when at least the anomaly of the industrial device 10 is riot classifiable based on the sensor signal or the anomaly is smaller than a preset number of samples, and the transmission unit 214 may transmit the sensor signal classified as unknown data to the server 30.

Thereby, the diagnostic device 20 can reduce the load on the network by transmitting only the sensor signal of the sensor data, which is determined to be unknown data in the server 30, to the server 30.

(3) In the diagnostic device 20 according to (1) or (2) described above, the device diagnosis unit 212 may be a one-class classifier that learns characteristics of the sensor signal in a normal state in advance and detects the anomaly of the industrial device 10 based on a degree of deviation from the characteristics in the normal state

Thereby, the diagnostic device 20 can easily diagnose the anomaly of the industrial device 10 based on the sensor data.

(4) In the diagnostic: device 20 according to any one of (1) to (3) described above, the diagnostic device 20 may further include a label information generation unit 216 configured to determine, based on the classification result by the classification unit 213, a generation timing of a label indicating a content of the anomaly of the industrial device 10 with respect to the sensor signal and generates the label, in which the transmission unit 214 may transmit the sensor signal and the label to the server 30.

Thereby, the diagnostic device 20 can reduce the load on the user by labeling only the sensor signal of the sensor data determined to be unknown data in the server 30.

(5) In the diagnostic device 20 according to (4) described above, the classification unit 213 may acquire, from the server 30, the classification learning model generated by the server 30 based on the sensor signal and the label transmitted by the transmission unit 214.

Thereby, the diagnostic device 20 can easily diagnose the anomaly or the industrial device 10 based on the sensor data.

(6) In the diagnostic device 20 according to (5), the classification learning model may be updated whenever the server 30 receives a new sensor signal from the diagnostic device 20, and the classification unit 213 may classify the anomaly of the industrial device 10 using the updated classification learning model.

Thereby, the diagnostic device 20 can improve the accuracy of classification.

(7) In the diagnostic device 20 according to any one of (1) to (6) described above, the diagnostic device 20 may further include a display control unit 215 configured to display, on a display unit 22, a user interface that prompts to transmit the sensor signal when the transmission unit 214 transmits the sensor signal.

Thereby, the diagnostic device 20 can transmit the sensor signal to the server 30 at the, timing desired by the user.

(8) In the diagnostic device 20 according to (7) described above, the display control unit 215 may display at least one of the diagnosis result by the device diagnosis unit 212 and the classification result by the classification unit 213 on the display unit 22.

Thereby, the user can confirm whether the anomaly occurs in the industrial device 10 and the occurrence of the anomaly.

(9) An aspect of the diagnostic device 20A of the present disclosure provides a diagnostic device that is communicatively connected to a server 30A including a classification learning model to which a sensor signal indicating an anomaly acquired by an industrial device 10 is input to classify the anomaly and configured to learn a classification of the sensor signal that is not classifiable and to update the classification learning model, the diagnostic device including: a sensor signal acquisition unit 210 configured to acquire a sensor signal including a measurement value measured by at least one sensor 11 arranged in the industrial device 10; a device diagnosis unit 212 configured to diagnose based on the acquired sensor signal whether the industrial device 10 is normal or anomalous; a transmission unit 214a configured to transmit the sensor signal to the server 30A when the device diagnosis unit 212 diagnoses that the industrial device 10 is anomalous; and a label information generation unit 216a configured to determine, based on a classification result for the sensor signal acquired from the server 30A, a generation timing of a label indicating a content of the anomaly of the industrial device 10 with respect to the sensor signal and generates the label, in which the transmission unit 214a transmits the label to the server 30A.

According to the diagnostic device 20A, the same effect as in (1) described above can be obtained.

(10) An aspect of the server 30 of the present disclosure provides a server that is communicatively connected to the diagnostic device 20 according to any one of (1) to (8) describe above, the server including a classification model learning unit 31 configured to learn the anomaly of the industrial device 10 using the sensor signal received from the diagnostic device 20, generates the classification learning model, and transmits the generated classification learning model to the diagnostic device 20.

According to the server 30, it is possible to receive only the data that has a great influence on the functional improvement at the vender.

(11) An aspect of the server 30A of the present disclosure provides a server that is communicatively connected to the diagnostic device 20A according to (9) described above, the server including: a classification model learning unit 31 configured to learn the anomaly of the industrial device 10 using a sensor signal received from the diagnostic device 20A and generates the classification learning model; and a classification unit 32 configured to classify the anomaly of the industrial device 10 based on the sensor signal and the classification learning model.

According to the server 30A, it is possible to receive only the data that has a great influence on the functional improvement at the vender.

(12) An aspect of the diagnostic method of the present disclosure provides a diagnostic method using a diagnostic device 20 that is communicatively connected to a server 30 configured to learn an anomaly of an industrial device 10 and to generate a classification learning model for the anomaly, the diagnostic method including: a sensor signal acquisition step of acquiring a sensor signal including a measurement value measured by at least one sensor arranged in the industrial device 10; a device diagnosis step of diagnosing, based on the acquired sensor signal, whether the industrial device at as normal or anomalous; a classification step of classifying the anomaly of the industrial device 10 based on the sensor signal and the classification learning model when the industrial device 10 is diagnosed to be anomalous; and a transmission step of determining, based on at least one of a diagnosis result in the device diagnosis step and a classification result in the classification step, whether to transmit the sensor signal to the server 30, and transmitting the sensor signal to the server 30 when it is determined that the sensor signal can be transmitted.

According to the diagnostic method, the same effect as in (1) described above can be obtained.

(13) An aspect of the diagnostic method of the present disclosure provides a diagnostic method using a diagnostic device 20A that is communicatively connected to a server 30A including a classification learning model to which a sensor signal indicating an anomaly acquired by an industrial device 10 is input to classify the anomaly and configured to learn a classification of the sensor signal that is not classifiable and to update the classification learning model, the diagnostic method including: a sensor signal acquisition step of acquiring a sensor signal including a measurement value measured by at least one sensor 11 arranged in the industrial device 10; a device diagnosis step of diagnosing, based on the acquired sensor signal, whether the industrial device 10 is normal or anomalous; a transmission step of transmitting the sensor signal to the server 30A when the industrial device 10 is diagnosed to be anomalous; and a label information generation step of determining, based on a classification result for the sensor signal acquired from the server 30A, generation timing of a label indicating a content of the anomaly of the industrial device 10 with respect to the sensor signal and generating the label, in which the transmission step includes transmitting the label to the server 30A.

According to the diagnostic method, the same effect as in (1) described above can be obtained.

### EXPLANATION OF REFERENCE NUMERALS

1 diagnosis system

10 industrial device

11 sensor

20, 20A diagnostic device

21, 21a control unit

211 sensor signal acquisition unit

212 device diagnosis unit

213 classification unit

214, 214a transmission unit

215 display control unit

216, 216a label information generation unit

22 display unit

30, 30A server

31 classification model learning unit

32 classification unit

1. A diagnostic device that is communicatively connected to a server configured to learn an anomaly of an industrial device and to generate a classification learning model for the anomaly, the diagnostic device comprising:
a sensor signal acquisition unit configured to acquire a sensor signal including a measurement value measured by at least one sensor arranged in the industrial device;
a device diagnosis unit configured to diagnose based on the acquired sensor signal whether the industrial device is normal or anomalous;
a classification unit configured to classify the anomaly of the industrial device based on the sensor signal and the classification learning model when the device diagnosis unit diagnoses that the industrial device is anomalous; and
a transmission unit configured to determine, based on at least one of a diagnosis result by the device diagnosis unit and a classification result by the classification unit, whether to transmit the sensor signal to the server, and transmits the sensor signal to the server when it is determined that the sensor signal can be transmitted.

2. The diagnostic device according to claim 1, wherein the classification unit classifies the sensor signal as unknown data when at least the anomaly of the industrial device is not classifiable based on the sensor signal or the anomaly is smaller than a preset number of samples, and
the transmission unit transmits the sensor signal classified as unknown data to the server.

3. The diagnostic device according to claim 1, wherein the device diagnosis unit is a one-class classifier that learns characteristics of the sensor signal in a normal state in advance and detects the anomaly of the industrial device based on a degree of deviation from the characteristics in the normal state.

4. The diagnostic device according to claim 1, further comprising a label information generation unit configured to determine, based on the classification result by the classification unit, a generation timing of a label indicating a content of the anomaly of the industrial device with respect to the sensor signal and generates the label, wherein
the transmission unit transmits the sensor signal and the label to the server.

5. The diagnostic device according to claim 4, wherein the classification unit acquires, from the server, the classification learning model generated by the server based on the sensor signal and the label transmitted by the transmission unit.

6. The diagnostic device according to claim 5, wherein the classification learning model is updated whenever the server receives a new sensor signal from the diagnostic device, and the classification unit classifies the anomaly of the industrial device using the updated classification learning model.

7. The diagnostic device according to claim 1, further comprising a display control unit configured to display, on a display unit, a user interface that prompts to transmit the sensor signal when the transmission unit transmits the sensor signal.

8. The diagnostic device according to claim 7, wherein the display control unit displays at least one of the diagnosis result by the device diagnosis unit and the classification result by the classification unit on the display unit.

9. A diagnostic device that is communicatively connected to a server including a classification learning model to which a sensor signal indicating an anomaly acquired by an industrial device is input to classify the anomaly and configured to learn a classification of the sensor signal that is not classifiable and to update the classification learning model, the diagnostic device comprising:
a sensor signal acquisition unit configured to acquire a sensor signal including a measurement value measured by at least one sensor arranged in the industrial device;
a device diagnosis unit configured to diagnose based on the acquired sensor signal whether the industrial device is normal or anomalous;
a transmission unit configured to transmit the sensor signal to the server when the device diagnosis unit diagnoses that the industrial device is anomalous; and
a label information generation unit configured to determine, based on a classification result for the sensor signal acquired from the server, a generation timing of a label indicating a content of the anomaly of the industrial device with respect to the sensor signal and generates the label, wherein
the transmission unit transmits the label to the server.

10. A server that is communicatively connected to the diagnostic device according to claim 1, the server comprising:
a classification model learning unit configured to learn the anomaly of the industrial device using a sensor signal received from the diagnostic device, generates the classification learning model, and transmits the generated classification learning model to the diagnostic device.

11. A server that is communicatively connected to the diagnostic device according to claim 9, the server comprising:
a classification model learning unit configured to learn the anomaly of the industrial device using a sensor signal received from the diagnostic device and generates the classification learning model; and
a classification unit configured to classify the anomaly of the industrial device based on the sensor signal and the classification learning model.

12. A diagnostic method using a diagnostic device that is communicatively connected to a server configured to learn an anomaly of an industrial device and to generate a classification learning model for the anomaly, the diagnostic method comprising:
a sensor signal acquisition step of acquiring a sensor signal including a measurement value measured by at least one sensor arranged in the industrial device;
a device diagnosis step of diagnosing, based on the acquired sensor signal, whether the industrial device is normal or anomalous;
a classification step of classifying the anomaly of the industrial device based on the sensor signal and the classification learning model when the industrial device is diagnosed to be anomalous; and
a transmission step of determining, based on at least one of a diagnosis result in the device diagnosis step and a classification result in the classification step, whether to transmit the sensor signal to the server, and transmitting the sensor signal to the server when it is determined that the sensor signal can be transmitted.

13. A diagnostic method using a diagnostic device that is communicatively connected to a server including a classification learning model to which a sensor signal indicating an anomaly acquired by an industrial device is input to classify the anomaly and configured to learn a classification of the sensor signal that is not classifiable and to update the classification learning model, the diagnostic method comprising:
a sensor signal acquisition step of acquiring a sensor signal including a measurement value measured by at least one sensor arranged in the industrial device;
a device diagnosis step of diagnosing, based on the acquired sensor signal, whether the industrial device is normal or anomalous;
a transmission step of transmitting the sensor signal to the server when the industrial device is diagnosed to be anomalous; and
a label information generation step of determining, based on a classification result for the sensor signal acquired from the server, a generation timing of a label indicating a content of the anomaly of the industrial device with respect to the sensor signal and generating the label, wherein
the transmission step includes transmitting the label to the server.
